(19) United States
(12) Patent Application Publication
(10) Pub. No.: US 2025/0200516 A1
(43) Pub. Date: Jun. 19, 2025

(54) SYSTEMS AND METHODS TO GENERATE SUBORDINATE WORK UNIT RECORDS BASED ON TEMPLATES AND/OR CREATE TEMPLATES FOR SUBORDINATE WORK UNIT RECORDS OF A COLLABORATION ENVIRONMENT

(71) Applicant: Asana, Inc., San Francisco, CA (US)

(72) Inventors: Anna Marie Clifton, San Francisco, CA (US); Micah Hanan Fenner, San Francisco, CA (US); William Bloomquist, Menlo Park, CA (US); John Joseph Welsh, San Francisco, CA (US); Victoria Ye, Bellevue, WA (US)

(21) Appl. No.: 17/553,521

(22) Filed: Dec. 16, 2021

Related U.S. Application Data
(60) Provisional application No. 63/261,391, filed on Sep. 20, 2021.

(51) Int. Cl. G06Q 10/10; G06Q 10/101

(52) U.S. Cl. CPC G06Q 10/103; G06Q 10/101

(57) ABSTRACT

Systems and methods to generate subordinate work unit records based on templates and/or create templates for subordinate work unit records of a collaboration environment are described herein. Exemplary implementations may: manage environment state information maintaining a collaboration environment; manage template information defining templates for work unit records of the collaboration environment; obtain input information conveying user input into a user interface of the collaboration environment to implement the templates to create individual sets of subordinate work unit records and/or to generate templates based on sets of subordinate work unit records included in the environment state information; create the sets of subordinate work unit records based on the templates; effectuate presentation of work unit pages of the work unit records through which the users access the work unit records; generate templates based on sets of subordinate work unit records included in the environment state information; and/or perform other operations.

### FIELD OF THE DISCLOSURE

The present disclosure relates to systems and methods to generate subordinate work unit records based on templates and/or create templates for subordinate work unit records of a collaboration environment.

### BACKGROUND

Collaboration environments, sometimes referred to as work management platforms, may enable users to assign projects, tasks, or other assignments to assignees (e.g., other users) to complete. A collaboration environment may comprise an environment in which individual users and/or a virtual team of users does its work and may enable users to work in a more organized and efficient manner.

### SUMMARY

Hosting a web-based collaboration environment poses many challenges. For example, operating the collaboration environment may require precise ways of creation, storage, management, and/or provision of information that makes up the collaboration environment. One way that operators look to improve the operation of the collaboration environment is to improve parts of the collaboration environment involving substantial human-machine interaction. For example, users may traditionally manually generate records for their work within the collaboration environment. Further, the ways in which work is organized may similar across different types of work, so users may find them themselves repeating the same actions over and over again. The operators of the collaboration environment were traditionally tasked with finding ways to design and configure user interfaces which would provide user-friendly and intuitive ways to receive this manual input and/or decrease the friction causes by repetitive user actions. However, even with improved user interfaces that walk through manual generation of records, the requirement for human-machine interactions is time consuming, may cause decreased workflow efficiency, and/or may be prone to user error.

One or more aspects of the present disclosure relates to a system configured to generate subordinate work unit records based on templates and/or create templates for subordinate work unit records of a collaboration environment. A work unit record may store information defining a unit of work. The creation of a work unit record may traditionally require a user to manually input information into a user interface in order to fully encompass the scope of a unit of work. A work unit record may include one or more subordinate work unit records representing subunits of work. By way of non-limiting illustration, a unit of work may be a task, and subordinate units of work may be subtasks. In some implementations, completion of a superior unit of work may be dependent on completion of one or more subordinate units of work. In some workflows, the same or similar sets of subordinate units of work may be created over and over again for different iterations of a superior unit of work. This repetitive manual intervention by users to create sets of subordinate units of work is time consuming and may create friction between the users and the collaboration environment, thereby reducing user efficiency and/or the effectiveness of the collaboration environment as a whole.

One or more implementations presented herein propose a way to generate subordinate work unit records from templates. A template may specify preset information for one or more subordinate units of work, and/or constraints on information within the one or more subordinate units of work that is to be determinable upon implementation of the template. One or more implementations presented herein propose a way to create the templates. In some implementations, templates may be specified by individual users. In some implementations, templates may be created from existing ones of the subordinate work unit records. A template created from an existing set of subordinate work unit records may take on information of the existing work unit record as preset (or predetermined) information, and/or may derive constraints from the information included in the existing set of subordinate work unit records. The templates may thereafter provide a way to automate the process of creating new sets of subordinate work unit records, by automatically populating information and/or determining information upon implementation of a template. The templates may save time when creating units of work that are similar to past units of work. Additionally, the templates may assure that critical information may be carried out into new units of work.

One or more implementations of a system to generate subordinate work unit records based on templates and/or create the templates for subordinate work unit records of a collaboration environment may include one or more hardware processors configured by machine-readable instructions and/or other components. Executing the machine-readable instructions may cause the one or more hardware processors to facilitate generation of subordinate work unit records based on templates and/or creation of templates for subordinate work unit records of a collaboration environment. The machine-readable instructions may include one or more computer program components. The one or more computer program components may include one or more of an environment state component, a template component, a user input component, a records component, a user interface component, and/or other components.

The environment state component may be configured to manage environment state information and/or other information. The environment state information may maintain a collaboration environment. The collaboration environment may be configured to facilitate interaction by users with the collaboration environment. The environment state information may include one or more records. The one or more records may include one or more of work unit records, user records, and/or other records. The work unit records may include work information associated with units of work managed, created, and/or assigned within the collaboration environment. The user records may include user information associated with the users. In some implementations, the work information may include hierarchical information and/or other information. The hierarchical information may characterize a record hierarchy for one or more work unit records. A record hierarchy may specify that individual work unit records are subordinate work unit records. A record hierarchy may specify that individual work unit records are superior work unit records. By way of non-limiting illustration, the work unit records may include a first work unit record for a first unit of work and/or other records.

The template component may be configured to manage template information defining templates for work unit records. Individual templates may facilitate creation of individual sets of the subordinate work unit records based on templated work information of the individual templates. The templated work information may include work information in template form, meaning, that the templated work information may be executed and/or implemented to create one or more subordinate units of work. By way of non-limiting illustration, a first template may facilitate creation of a first set of subordinate work unit records based on first templated work information.

The user input component may be configured to obtain input information conveying user input into a user interface of the collaboration environment. The user interface may include requests to implement the templates to create the sets of the subordinate work unit records. An individual set of the subordinate work unit records may be created in relation to an other work unit record (which may be designated as a superior work unit record). By way of non-limiting illustration, the input information may convey first user input by a first user into the user interface to implement the first template.

The records component may be configured to create individual sets of subordinate work unit records based on implementation of the templated work information of the individual templates. By way of non-limiting illustration, the first set of subordinate work unit records may be created based on an implementation of the first templated work information of the first template. The first templated work information of the first template may be implemented with respect to the first work unit record. The first set of subordinate work unit records may be created as being subordinate to the first work unit record.

The records component may be configured to present work unit pages of the work unit records through which the users access the work unit records. By way of non-limiting illustration, a first work unit page for the first work unit record may be presented. The first work unit page may display one or more of work information of the first work unit record, the first set of subordinate work unit records that are subordinate to the first work unit record, and/or other information.

In some implementations, for creating templates, the user input component may be configured to obtain input information conveying user input into a user interface of the collaboration environment to generate one or more templates based on one or more of the work unit records included in the environment state information. The input information may convey second user input by a second user to generate a second template based on a second set of subordinate work unit records. The second set of subordinate work unit records may be subordinate to a second work unit record.

The template component may be configured to generate, in response to the user input, one or more of the templates based on the one or more of the work unit records included in the environment state information. By way of non-limiting illustration, the second template may be generated based on the second set of subordinate work unit records. The second template may include second templated work information. The second templated work information may be derived from the work information associated with the second set of subordinate work unit records and/or other information.

As used herein, any association (or relation, or reflection, or indication, or correspondency) involving servers, processors, client computing platforms, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1).

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system to generate subordinate work unit records based on templates and/or create templates for work unit records of a collaboration environment, in accordance with one or more implementations.

FIG. 2a illustrates a method to generate subordinate work unit records based on templates, in accordance with one or more implementations.

FIG. 2b illustrates a method to create templates for subordinate work unit records of a collaboration environment, in accordance with one or more implementations.

FIG. 3 illustrates a user interface, in accordance with one or more implementations.

FIG. 4 illustrates a user interface, in accordance with one or more implementations.

FIG. 5 illustrates a user interface, in accordance with one or more implementations.

FIG. 6 illustrates a user interface, in accordance with one or more implementations.

FIG. 7 illustrates a user interface, in accordance with one or more implementations.

### DETAILED DESCRIPTION

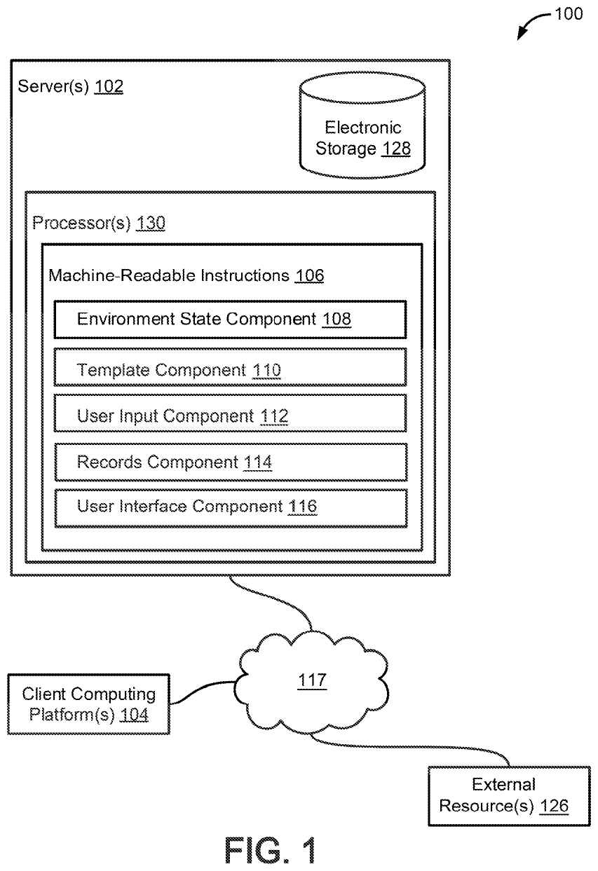

FIG. 1 illustrates a system 100 configured to generate subordinate work unit records based on templates and/or create templates for subordinate work unit records of a collaboration environment, in accordance with one or more implementations. Work unit records may include work information associated with units of work managed, created, and/or assigned within the collaboration environment. A work unit record may include one or more subordinate work unit records representing subunits of work. By way of non-limiting illustration, a unit of work may be a task, and subordinate units of work may be subtasks. In some implementations, completion of a superior unit of work may be dependent on completion of one or more subordinate units of work. However, subordinate units of work may have other relationships with respect to superior units of work.

In some implementations, the system 100 may obtain user input to implement a template causing the creation of sets of subordinate work unit records based on the template and/or other information. Implementation of templates may be caused in other ways. The sets of subordinate work unit records may include predetermined information and/or determinable information which may be dictated by rules and/or constraints. In some implementations, the system 100 may facilitate the generation of templates. In some implementations, the templates may be generated based on existing sets of subordinate work unit records. In some implementations, the templates may be generated “from scratch” by users manually specifying elements of the templates.

In some implementations, system 100 may include one or more of one or more servers 102, one or more client computing platforms 104, external resource(s) 126, and/or other components. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may include one or more of non-transitory electronic storage 128, one or more processors 130 configured by machine-readable instructions 106, and/or other components. The non-transitory electronic storage 128 may store one or more records and/or other information. Machine-readable instructions 106 may include one or more instruction components. The instruction components may include computer program components. Executing the machine-readable instructions 106 may cause server(s) 102 to facilitate generating subordinate work unit records based on templates and/or generating the templates. The computer program components may include one or more of an environment state component 108, a template component 110, a user input component 112, a records component 114, a user interface component 116, and/or other components.

Environment state component 108 may be configured to manage environment state information and/or other information used in maintaining a collaboration environment. The collaboration environment may be configured to facilitate interaction by users with the collaboration environment. The environment state information may include one or more of work unit records, project records, objective records, user records, and/or other records. The work unit records may include work information comprising values for work unit parameters associated with units of work managed, created, and/or assigned within the collaboration environment. The project records may include project information comprising values for project parameters associated with project created, assigned, and/or managed within the collaboration environment. The objective records may include objective information comprising values for objective parameters associated with business objectives defined within the collaboration environment.

The work information in the work unit records may include values for work unit parameters. The values of the work unit parameters may be organized in work unit records corresponding to units of work managed, created, and/or assigned within the collaboration environment. A given unit of work may have one or more assignees and/or collaborators working on the given work unit. Units of work may include one or more to-do items, action items, and/or other expressions of units of work one or more users should accomplish and/or plan on accomplishing. Units of work may be created by a given user for the given user and/or created by the given user and assigned to one or more other users. Individual units of work may include one or more of an individual task, an individual sub-task (referred to herein as a “subordinate” unit of work), and/or other units of work assigned to and/or associated with one or more users. Individual units of work may include one or more digital content items. An individual unit of work may include an individual digital content item by virtue of the individual digital content item (and/or a copy or instance thereof) being attached and/or appended thereto. A digital content item may include one or more of an image, a video, an audio file, a PDF, a word document, and/or other digital content items.

In some implementations, units of work created by, assigned to, and/or completed by the users may refer generally to a linking of the units of work with the individual users in the collaboration environment. A unit of work may be linked with a user in a manner that defines one or more relationships between the user and the unit of work. Such a relationship may connote and/or be a result of an action (past, present, and/or future) of the user with respect to the unit of work. Such actions may include one or more of creating a work unit record for a unit of work, being assigned to participate in a unit of work, participating in a unit of work, being granted access to a work unit record of a unit of work, adjusting a value of a work unit parameter of a work unit record of a unit of work, and/or other actions.

Individual sets of work unit records may be defined by a record hierarchy. A record hierarchy may convey individual positions of work unit records (and their corresponding units of work) in the record hierarchy. By way of non-limiting illustration, a position may specify one or more of a work unit record being superior to another work unit record, a work unit record being subordinate to another work unit record, and/or other information. As a result, individual work unit records in the individual sets of work unit records may be subordinate to other individual work unit records in the individual sets of work unit records. The record hierarchy may specify that individual work unit records are subordinate work unit records. The record hierarchy may specify that individual work unit records are superior work unit records. For example, a work unit record may define a unit of work comprising a task, and a subordinate work unit record may define a unit of work comprising a sub-task to the task. A record hierarchy may define a relationship between work unit records. A work unit record may have some restrictions placed on it by virtue of having a subordinate work unit record. By way of non-limiting illustration, a superior work unit record may be restricted from being completed by one or more users unless and/or until one or more subordinate work unit records are completed and/or started. In other words, the superior work unit record may be dependent on the subordinate work unit record.

Individual work unit records may include hierarchical information defining a record hierarchy of the individual work unit records. The hierarchical information of a work unit record may include one or more of information identifying other work unit records associated in a record hierarchy the work unit record belongs to, a specification of the position of the work unit record in the hierarchy, restrictions and/or other relationships placed on the work unit record by virtue of its position (e.g., dependency status), and/or other information.

In some implementations, values of work unit parameters may include one or more of a unit of work name, a unit of work description, one or more unit of work dates (e.g., a start date, a due date or end date, a completion date, and/or dates), one or more users linked to a unit of work (e.g., an owner, one or more collaborators, collaborator access information, and/or other information), role information, a status parameter (e.g., an update, a hardcoded status update, a completed/incomplete/mark complete, a measured status, a progress indicator, quantity of sub-work units remaining for a given unit of work, measure of urgency, and/or other status parameter), one or more user comment parameters (e.g., permission for who may make comments such as an assignee, an assignor, a recipient, one or more followers, and/or one or more other interested parties; content of the comments; one or more times; presence or absence of the functionality of up-votes; one or more hard-coded responses; and/or other parameters), one or more interaction parameters (e.g., indicating a given unit of work is being worked on/was worked on, a given work unit of work was viewed, a given unit of work was selected, how long the given unit of work has been idle, a last interaction parameter indicating when and what user last interacted with the given unit of work, users that interacted with the given unit of work, quantity and/or content of comments on the unit of work, and/or other interaction parameters indicating sources of the interactions, context of the interactions, content of the interactions and/or time for the interactions), one or more digital content item attachments, notification settings, privacy, an associated URL, one or more interaction parameters (e.g., sources of the interactions, context of the interactions, content of the interactions, time for the interactions, and/or other interaction parameters), updates, ordering of units of work within a given unit of work (e.g., tasks within a project, subtasks within a task, etc.), state of a workspace for a given unit of work (e.g., application state parameters, application status, application interactions, user information, and/or other parameters related to the state of the workspace for a unit of work), one or more performance/productivity metrics for a given unit of work, hierarchical information, one or more custom fields (e.g., priority, cost, stage, and/or other custom fields), and/or other information.

In some implementations, the one or more work unit parameters may include one or more of a work assignment parameter, work completion parameter, a work management parameter, work creation parameter, and/or other parameters. The values of the work assignment parameter may describe assignment of units of work to the individual users. The values of the work management parameter may describe managers and/or management requirements for units of work. The values of the work creation parameter may characterize the creation of units of work by the individual users.

The values of the work assignment parameter may be determined based on one or more interactions by one or more users with a collaboration environment. In some implementations, one or more users may assign one or more units of work to themselves and/or another user. In some implementations, a user may be assigned a unit of work and the user may effectuate a reassignment of the unit of work from the user or one or more other users.

In some implementations, values of the work completion parameter may indicate that a status a unit of work has changed from “incomplete” to “marked complete” and/or “complete”. In some implementations, a status of complete for a unit of work may be associated with the passing of an end date associated with the unit of work. In some implementations, a status of “marked complete” may be associated with a user providing input via the collaboration environment at the point in time the user completes the unit of work (which may be before or after an end date).

In some implementations, managing by the environment state component 108 may include maintaining queues of the units of work assigned to the users. The queues may be presented to the users in a user interface of the collaboration environment to facilitate access to the units of work via work unit pages. Individual queues may represent the units of work assigned to individual users organized in an order based on the individual end dates and/or other dates (e.g., start dates) and/or other ordering. Individual queues may be presented in a user interface based on one or more of a list view, a calendar view, and/or other views. The calendar view may be a calendar view by week, by more than one week (e.g., 1^{st} through 15^{th}), by month, by more than one month (e.g., May through July), and/or other calendar views. Units of work may be representing in a calendar view by user interface elements (e.g., icons, calendar entries, etc.).

In some implementations, managing by the environment state component 108 may include maintaining queues of the subordinate units of work that are subordinate to a given unit of work. In some implementations, queues of subordinate units of work may be presented in work unit pages of the superior units of work. Individual queues of the subordinate units of work may be organized in an order based on the individual end dates and/or other dates (e.g., start dates) and/or other ordering. In some implementations, users may arrange the queues of subordinate units of work as needed.

Role information may be specified in one or more of the work unit records, user records, project records, and/or other records. The role information may specify roles of the users within the individual records, and/or a business organization as a whole. The roles may convey expected contribution of the users in completing and/or supporting the units of work.

A role may represent expected contribution of the users in completing and/or supporting the units of work. A role specified with respect to units of work may be different from roles traditionally specified with respect to a business organization as a whole (e.g., President, CEO, intern, product designer, legal counsel, etc.). For example, an organization role may be “Product Designer” and a role on an individual unit of work may be “Design Lead” or “Approver.”

A role within a unit of work may be specified based on one or more of a job title, a description of what the user should accomplish and/or plan on accomplishing for the given unit of work, and/or other specifications. By way of non-limiting illustration, a role within a unit of work may include one or more of general assignee, graphic designer, engineer, tester, writer, artist, mechanic, and/or other descriptions.

Project information in project records may define values of project parameters for projects created, assigned, and/or managed within the collaboration environment. The project parameters may characterize one or more projects managed within the collaboration environment and/or via the collaboration environment, and/or the metadata associated with the one or more projects. Individual ones of the projects may be associated with individual ones of the project records. The project information may define values of the project parameters associated with a given project managed within the collaboration environment and/or via the collaboration environment. A given project may have one or more owners and/or one or more collaborators working on the given project. The given project may include one or more units of work assigned to one or more users under the given project heading. In some implementations, projects may include one or more units of work that may directly facilitate progress toward fulfillment of the projects. Accordingly, completion of the set of units of work may directly contribute to progress toward fulfillment of the project. By way of non-limiting illustration, an individual project may be associated with a client and the units of work under the individual project heading may be work directly contributing to the fulfillment of a business relationship with the client.

The values of the project parameters may, by way of non-limiting example, include one or more of: one or more units of work supporting individual ones of the projects (which may include values of work unit parameters included in one or more work unit records), one or more users linked to the project (which may include values of user parameters defined by one or more user records), role information, one or more user comment parameters (e.g., a creator, a recipient, one or more followers, one or more other interested parties, content, one or more times, upvotes, other hard-coded responses, etc.), a project name, a project description and/or background summary, a project problem statement, a project solution statement, one or more risks associated with the project, one or more project dates (e.g., a start date, a due date, a completion date, and/or other project dates), one or more project collaborators (e.g., an owner, one or more other project collaborators, collaborator access information, and/or other information), a status and/or progress (e.g., an update, a hardcoded status update, a measured status, quantity of units of work remaining in a given project, completed units of work in a given project, and/or other status parameter), one or more resources, one or more demonstrable assets associated with a project, one or more business objectives supported by the projects, notification settings, permissions information, an associated URL, one or more interaction parameters (e.g., sources of the interactions, context of the interactions, content of the interactions, time for the interactions, and/or other interaction parameters), updates, ordering of units of work within the given project, hierarchical information, state of a workspace for a given task within the given project, and/or other information.

In some implementations, project records may include permissions information for the individual projects. The permissions may specify access restrictions for the individual project. The access restrictions may be specified on a user-basis, user role-bases (e.g., based on one or more of organization role, role in units of work, and/or project-level role), for groups of users, and/or specified in other ways).

A role within a project (e.g., a “project-level role”) may be specified based on a description of what the user may be supporting and/or plan on supporting for the given project, and/or other specifications. By way of non-limiting illustration, a role within a project may include one or more of owner, design, marketing, copy, legal, engineering, art director, and/or other descriptions. Although the specification of the role in a project may include the same or similar words as the role in a unit of work, the role in the project may enable and/or disable features within the collaboration environment otherwise not available to users of having roles in individual units of work but not at the project level. In some implementations, roles within a project may take on a more supervisory connotation than the roles within the individual units of work.

Individual sets of project records may be defined by a project record hierarchy. A project record hierarchy may convey individual positions of project records (and their corresponding projects) in the project record hierarchy. Individual project records may include hierarchical information defining a project record hierarchy of the individual project records. The hierarchical information of a project record may include one or more of information identifying other project records associated in a project record hierarchy the project record belongs to, a specification of the position of the project record in the hierarchy, other relationships placed on the project record by virtue of its position, and/or other information.

Users may access individual project records through individual project pages displaying the individual projects. The individual project pages may include dedicated interface that present one or more values of one or more of the project parameters for individual project records and provide access to the underlying individual project records. By way of non-limiting illustration, editing on individual project pages may cause individual project records to be updated.

The objective information in objective records may include values of one or more objective parameters. The values of the objective parameters may be organized in objective records corresponding to business objectives managed, created, and/or owned within the collaboration environment. A given business objective may have one or more collaborators, and/or team members working on the given business objective. Business objectives may include one or more associated units of work one or more users should accomplish and/or plan on accomplishing. Business objectives may be created by a given user for the given user and/or created by the given user and assigned to be owned to one or more other users. Individual business objectives may include one or more of an individual goal, an individual sub-goal, and/or other business objectives assigned to be owned by a user and/or associated with one or more users.

The business objectives may be associated with a set of units of work that may indirectly facilitate progress toward fulfillment of the business objectives. The set of units of work may not directly contribute to the progress. By way of non-limiting illustration, a connection between the set of units of work and a corresponding business objective may be indirect in that completion of at least one of the units of work may have no direct impact on progress toward fulfillment of the business objective. The concept of “no direct impact” may mean that completion of the at least one unit of work may not cause progress toward fulfillment of the business objective without independent action outside of the at least one unit of work. Instead, the fulfillment of the at least one unit of work may make such independent action more likely (e.g., through coercion, assistance, education, incentivization, reminder, etc.). However, in some implementations, business objectives may be associated with a set of units of work that may directly facilitate progress toward fulfillment of the business objectives. Accordingly, completion of the set of units of work may directly contribute to the progress toward fulfillment. Business objectives may be associated with an objectives and key result (OKR) goal-setting framework. Business objectives may be specified on one or more of a team basis, organization basis, and/or other specifications. In some implementations, business objectives may be characterized as user objectives. The user objectives may be associated with a set of units of work that may indirectly (and/or directly) facilitate progress toward fulfillment of the user objectives. User objectives may be specified on an individual user basis.

Individual objective records may describe individual business objectives and identify sets of individual ones of the work unit records and/or project records that specify the units of work and/or projects as being associated with the individual business objectives.

Individual sets of objective records may be defined by an objective record hierarchy. An objective record hierarchy may convey individual positions of objective records (and their corresponding business objectives) in the objective record hierarchy. By way of non-limiting illustration, a position may specify one or more of an objective record being superior to one or more other objective records, an objective record being subordinate to one or more other objective records, and/or other information. As a result, individual objective records may be subordinate and/or superior to other individual objective records. For example, the objective records may further include a second objective record. The first objective record and the second objective record may be organized by a first objective record hierarchy specifying that the second objective record is subordinate to the first objective record.

An objective record may define a business objective comprising a progress towards fulfillment, and a subordinate objective record may define a business objective comprising a subordinate progress towards fulfillment to the subordinate business objective. An objective record hierarchy may define a relationship between objective records.

Individual objective records may include hierarchical information defining an objective record hierarchy of the individual objective records. The hierarchical information of an objective record may include one or more of information identifying other objective records associated in an objective record hierarchy the objective record belongs to, a specification of the position of the objective record in the hierarchy, other relationships placed on the objective record by virtue of its position, and/or other information.

In some implementations, as a consequence of the objective record hierarchies, the individual business objectives described in the individual objective records that are subordinate to the other individual objective records may be subordinate to the individual business objectives in the other individual objective records.

In some implementations, the one or more objective parameters may include one or more of an objective definition parameter, an objective owner parameter, an objective management parameter, an objective creation parameter, an objective progress parameter, and/or other parameters. The value of the objective definition parameter may describe the particular business objective. The values of the objective owner parameter may describe business objectives assigned to be owned by an individual user. The values of the objective management parameter may describe business objectives managed as collaborators by the individual users. The values of the objective creation parameter may describe business objectives created by the individual users.

In some implementations, the business objectives may be described based on one or more of a business objective name, a business objective description, one or more business objective dates (e.g., a start date, a due date, and/or dates), one or more members associated with a business objective (e.g., an owner, one or more other project/task members, member access information, and/or other business objective members and/or member information), progress information (e.g., an update, a hardcoded status update, a measured status, a progress indicator, quantity value remaining for a given business objective, completed work units in a given project, and/or other progress information), one or more interaction parameters, notification settings, privacy, an associated URL, one or more custom fields (e.g., priority, cost, stage, and/or other custom fields), and/or other information.

The values of the objective owner parameter describing business objectives owned by the individual users may be determined based on one or more interactions by one or more users with a collaboration environment. In some implementations, one or more users may create and/or assign ownership of one or more business objectives to themselves and/or another user. In some implementations, a user may be assigned to own a business objective and the user may effectuate a reassignment of ownership of the business objective from the user or one or more other users.

The values of the user parameters may be organized in user records corresponding to users interacting with and/or viewing the collaboration environment. The values of the user parameters may include information describing the users, their actions within the collaboration environment, their settings, and/or other user information; and/or metadata associated with the users, their actions within the environment, their settings, and/or other user information. Individual ones of the users may be associated with individual ones of the user records. A user record may define values of the user parameters associated with a given user.

The values of the user parameters may, by way of non-limiting example, specify one or more of: a user name, a group parameter, a user account, role information, a user department, descriptive user content, a to-email, a from-email, a photo, an organization, a workspace, one or more user comments, one or more teams the user belongs to, one or more of the user display settings (e.g., colors, size, project order, task order, other unit of work order, etc.), one or more authorized applications, one or more interaction parameters (e.g., indicating a user is working on/worked on a given unit of work, a given user viewed a given work unit of work, a given user selected a given unit of work, a timeframe a given user last interacted with and/or worked on a given unit of work, a time period that a given unit of work has been idle, and/or other interaction parameters), one or more notification settings, one or more progress parameters, status information for one or more work units the user is associated with (units of work assigned to the user, assigned to other users by the user, completed by the user, past-due date, and/or other information), one or more performance/productivity metrics of a given user (e.g., how many units of work the user has completed, how quickly the user completed the units of work, how quickly the user completes certain types of work units, the efficiency of the user, bandwidth of the user, activity level of the user, how many business objectives the user has helped fulfill through their completion of units of work, etc.), application access information (e.g., username/password for one or more third-party applications), collaborator information, one or more favorites and/or priorities, schedule information, and/or other information. In some implementations, collaborator information may specify one or more other users a given user frequency collaborates with. “Frequently” may be defined with respect to a threshold. A threshold may include at least one collaboration. A threshold may include at least one collaboration with respect to at least one record. A threshold may include one or more collaborations over a given period of time.

The template component 110 may be configured to manage template information defining templates for work unit records. Individual templates may facilitate the creation of individual sets of subordinate work unit records. The individual templates may include templated work information and/or other information. The templated work information may include one or more of predetermined information, determinable information, and/or other information. The predetermined information may include individual sets of predetermined values for the work unit parameters. The determinable information may include individual sets of determinable values for the work unit parameters, and/or other information. Individual determinable values may be determined upon implementation of the individual templates. Individual determinable values of work unit parameters may be determined by rules and/or constraints placed on the determinable values by the template. By way of non-limiting illustration, a first template may be configured to facilitate the creation of a first set of subordinate work unit records (e.g., an instance thereof for the particular implementation of the template). The first template may include first templated work information and/or other information. The first set of subordinate work unit records may include a first subordinate work unit record and/or other subordinate work unit records. The first templated work information may include one or more of a first predetermined value of a first work unit parameter, a first determinable value for a second work unit parameter, and/or other information.

In some implementations, predetermined values of work unit parameters may include values that are automatically set to given values upon implementation of a template. By way of non-limiting illustration, predetermined values may include one or more of user assignments, user roles, digital content item attachments, relation to other work unit records (e.g., position in a hierarchy), and/or other information. By way of non-limiting illustration, when the first template is implemented to generate the first subordinate work unit record and/or other subordinate work unit records, a first work unit parameter for the first subordinate work unit record may be set to a first predetermined value.

The individual determinable values may be associated with one or more rules. Individual rules may dictate how to determine the individual determinable values. By way of non-limiting illustration, individual determinable values based on the context information and/or other information. The context information may convey context of the user input to implement the templates. The individual rules may dictate how context impacts the templated work information and/or how the subordinate work unit records may be ultimately generated. By way of non-limiting illustration, the one or more rules may provide relativistic determination of the determinable values based on the context of the implementation of a given template.

The context of the user input may include one or more of an identity of an individual user providing the user input to implement the individual templates, a record (e.g., source record) associated with a source page in which the user input to implement the individual templates is provided, one or more users linked to the record associated with the source page, a date and/or time of the user input to implement the individual templates, and/or other information. A source record may include a record being displayed in a user interface of the collaboration environment when user input to implement a template is provided. The source record may include one or more of a user record, a work unit record, a project record, an objective record, and/or other records.

In some implementations, an individual rule may indicate one or more of a role constraint, a date constraint, a source record constraint, and/or other constraints for determining individual determinable values based on the context information.

By way of non-limiting illustration, a role constraint may limit one or more of an assignee of a work unit record, an assignor of a work unit record, a manager of a work unit record, a collaborator of a work unit record, and/or other users linked to a work unit record to a user of a given role. By way of non-limiting illustration, a template may dictate that a work unit record created from the template is assigned to an “intern role” who is the intern of the user implementing the template. Accordingly, this value may be determined upon implementation of a template, where the identity of the user providing the input may be determined, and then an intern of the user providing the input may be determined. Therefore, the value is determinable, and able to be specifically determined upon implementation of the template.

A source record constraint may dictate that a specific source record is to be used to determined one or more determinable values. In some implementations, the source record constraint may dictate that a source record for a page from which a template is implemented is to be a superior record for a set of subordinate work unit record created using the template. In some implementations, the source record constraint may dictate that a source record for a page from which a template is implemented may be a source from with users are identified to set one or more user-related values (e.g., assignee of given role, etc.). Accordingly, one or more determinable values may be determined upon implementation of a template that rely on having a source record from which to derive information from.

A date constraint may dictate the date(s) associated with a work unit record (e.g., start date, end date, etc.). In some implementations, the date constraint may be specified relative to a date and/or time that the user provides input to implement a template, and/or other dates and/or times. By way of non-limiting illustration, a template may dictate that a subordinate work unit record created from the template has a due date that is one week following the date the template was implemented. Accordingly, this due date value may be determined upon implementation of a template, e.g., the value is determinable and able to be specifically determined upon implementation of the template. By way of non-limiting illustration, a template may dictate that a subordinate work unit record created from the template an implemented for a given superior work unit record has a due date that is one month before a due date of the superior work unit record.

The user input component 112 may be configured to obtain input information conveying user input into a user interface of the collaboration environment to implement the templates to create the individual sets of subordinate work unit records. In some implementations, a drop-down menu may be displayed in a page of a source record. The menu may include a list of available templates. The drop-down menu may include user interface elements configured to be selected to initiate a request to implement a template.

In some implementations, the user input component 112 may be configured to obtain the context information conveying context of the user input to implement the templates. By way of non-limiting illustration, the input information may convey first user input by a first user into the user interface to implement the first template.

The records component 114 may be configured to create the individual sets of subordinate work unit records. The records component 114 may be configured to create the individual sets of subordinate work unit records based on one or more of individual templates, context information, templated work information and/or other information. The records component 114 may be configured to create the individual sets of subordinate work unit records based on individual templates selected by users. In some implementations, the individual sets of subordinate work unit records may be created by determining the work information for the records based on one or more of the context information, templated work information, and/or other information.

By way of non-limiting illustration, the first subordinate work unit record and/or other subordinate work unit records may be created based on the first template. The first subordinate work unit record may include work information comprising the first predetermined value of the first work unit parameter, a first value of a second work unit parameter, and/or other values for other work unit parameters. The first value may be a specific determination of the first determinable value based on the context of the implementation of the first template.

The user interface component 116 may be configured to effectuate presentation of work unit pages of the work unit records through which the users access the work unit records and/or pages through which users access other records. The work unit pages may display one or more of the values of one or more of the work unit parameters for the individual work unit records and/or subordinate work unit records. The work unit pages may provide access to the underlying work unit records. By way of non-limiting illustration, editing on individual work unit pages may cause individual work unit records to be updated. By way of non-limiting illustration, a first work unit page for the first work unit record may be presented. The first work unit page may include work information for the first work unit record and/or work information for the first set of subordinate work unit records implementation for the first work unit record.

In some implementations, the user input component 112 may be configured to obtain input information conveying user input into a user interface of the collaboration environment to generate one or more templates. In some implementations, individual templates may be generated based on one or more of the work unit records included in the environment state information. In some implementations, individual templates may be generated “from scratch” based on user input. In some implementations, template creation may be facilitated in a dedicated user interface window and/or pop-up provided in response to a user request to create a template.

In some implementations, individual templates may include individual sets of interface elements and/or other content. An individual interface element may correspond to a display of values of an individual work unit parameter of an individual record. In creating a template, a user may provide input specifying a quantity of subordinate work unit records are to be included in a set of subordinate work unit records that are part of the template. In creating a template, a user may provide input into the given template (during creation) to specify individual predetermined values of individual work unit parameters for individual subordinate work unit records that are to be displayed in the individual interface element upon implementation of the template. In creating a template, a user may provide input into the given template to specify one or more rules that correspond to determinable values of individual work unit parameters for individual subordinate work unit records to be displayed in the individual interface element upon implementation of the template.

In some implementations, existing sets of subordinate work unit records may be selected to generate templates from. The user input may include one or more of identifying individual superior work unit records having individual sets of subordinate work unit records to generate individual templates from, individual sets of subordinate work unit records to generate individual templates from, specific input as to which of the values of the one or more of the work unit parameters of the individual subordinate units of work may be displayed in response to implementation of the template, and/or other input. In some implementations, when generating a template based on an existing set of subordinate work unit records, a “suggested content” portion may be presented. The suggested content portion may include suggestions about which of the values of the one or more of the work unit parameters of one or more of the subordinate work unit requires in the set should be considered predetermined values and/or which ones should be considered determinable values.

The template component 110 may be configured to generate, in response to user input, one or more templates based on one or more of the work unit records included in the environment state information. The template component 110 may be configured to obtain context information conveying context of the values of the work unit parameters of individual sets of subordinate work unit records from which templates are generated. The template component 110 may be configured to determine templated work information for the template(s) based on the context information and/or other information. The templated work information may specify and/or derive rules for individual determinable values based on the context information and/or other information.

In some implementations, context of the values of the work unit parameters of individual subordinate work unit records from which individual templates are generated may include constraints that currently apply to the values of the work unit parameters of individual subordinate work unit records from which the individual templates are generated. The template component 110 may be configured to determine templated work information. The templated work information may include one or more rules which, when executed via a template, apply the same constraints on a new subordinate work unit record as the subordinate work unit record used to generate the template in the first place. By way of non-limiting illustration, a subordinate work unit record may include an assignee that is the “manager” of a given project. A template created from the subordinate work unit record may have a determinable value which dictates an assignee of a subordinate work unit record created from the template to also include a user of a “manager” role.

By way of non-limiting illustration, input information may convey second user input by a second user to generate a second template based on a second set of subordinate work unit records. The second set of subordinate work unit records may be subordinate to a second work unit record. The second set of subordinate work unit records may include a second subordinate work unit record and/or other records. The second subordinate work unit record may include one or more of a third value of the first work unit parameter, a fourth value of the second work unit parameter, and/or other information. Second templated work information for the second template may be determined based on the context of the work information for the second set of subordinate work unit records. In response to the second user input, the second template may be generated based on the second set of subordinate work unit records. The second template may include, as the second templated information, the third value as a predetermined value of the first work unit parameter for a to-be-generated subordinate work unit record, a second determinable value for the second work unit parameter for the subordinate work unit record, and/or other information. The second determinable value may be derived from the fourth value. By way of non-limiting illustration, constraints associated with the fourth value may be determined. The constraints may be used to specify one or more rules that cause the same or similar constraints to be applied to the second work unit parameter of a subordinate work unit record generated from the second template.

In some implementations, environment state information may be updated as users continue to interact with the collaboration environment via the user interfaces over time. The environment state component 108 may store and/or archive the environment state information periodically and/or based on user request to archive. In some implementations, the environment state component 108 may store historical environment state information specifying historical user information, historical work information, historical project information, historical objective information, user interaction history, and/or other information.

The template component 110 may be configured to suggest one or more templates to users. In some implementations, a template may be suggested based on a given work unit record's origin. For example, a work unit record may be created from a template (or correspond to a subordinate record that would be created from a template), and a record of the use of that template may be stored. If the user wants to add additional records and/or sets of subordinate work unit records to that work unit record later on, template component 110 may be configured to suggest the correct subordinate work unit records to add since it is known what template the work unit record came from originally.

The records component 114 may be configured to identify one or more triggers that lead to creation of individual sets of subordinate work unit records based on templates. In some implementations, a trigger may include one or more of a user input specifically selecting a template, user input into a form submission (with or without direct selection of a template), a set of user-actions being carried out in the collaboration environment, and/or other triggers.

In some implementations, a user may submit a form, and the records component 114 may be configured to identify the content submitted in the form as triggering the creation of a set of subordinate units of work from a template. In some implementations, triggers in content of forms may include trigger words and/or phrases. By way of non-limiting illustration, the trigger phrases and/or words may include words and/or phrases conveying one or more of action items or tasks to be completed, desires or wants, and/or other information. In some implementations, the trigger phrases and/or words may include words accompanied by one or more of will you, can you, could you, please, by a given date, before the given date, we need, I need, I want, would be grateful if, you could, and/or other phrases and/or words. The records component 114 may be configured to identify a template that corresponds to the content of the form, create a set of subordinate work unit records based on the template, add the set of subordinate work unit records to a superior record, and/or perform other operations. In some implementations, a template may correspond to content of a form based on text making up the content of the form including the same or similar words as text making up the template. Correspondences may be determined in other ways.

In some implementations, records component 114 may be configured to identify a set of user-actions being carried out in the collaboration environment as triggering the creation of a set of subordinate units of work from a template. For example, when a user's work moves from stage to stage (as evidenced by their actions within the collaboration environment, e.g., completing tasks, starting others), records component 114 may be configured to identify the progress of the user's work as a trigger. The records component 114 may be configured to identify a template that corresponds to the user's work progress, create a set of subordinate work unit records based on the template, add the set of subordinate work unit records to a superior record, and/or perform other operations.

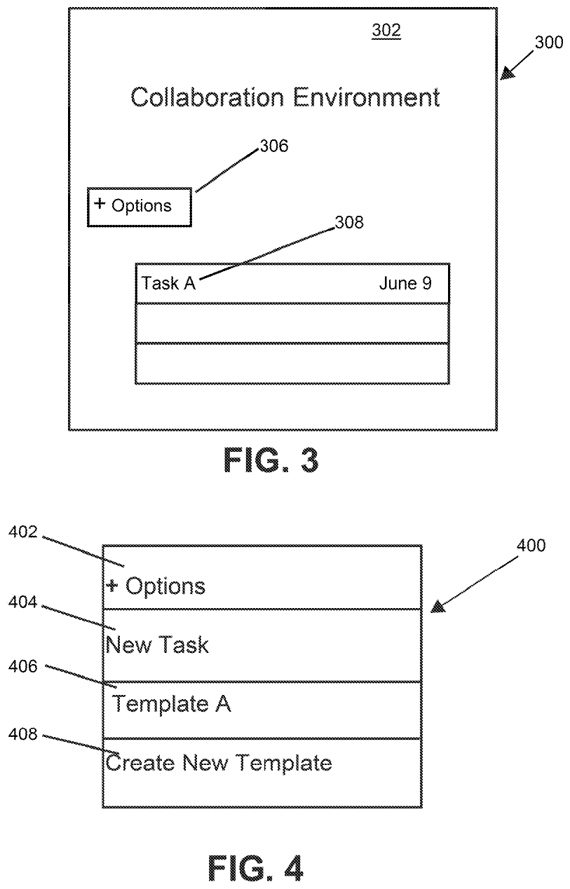

FIG. 3 illustrates a user interface 300, in accordance with one or more implementations. The user interface 300 may include a view of a collaboration environment 302. The collaboration environment 302 may comprise one or more portions. By way of non-limiting illustration, the collaboration environment 302 may include a first portion 306 displaying an interface element used to create work unit records for units of work (called “tasks”) and/or create templates, a second portion 308 displaying a list of units of work assigned to the given user, and/or other content. It is noted that this view of the collaboration environment 302 is not meant to be limiting and in some implementations may be specific to a user or team in which case there more portions and/or other portions included to the user interface 300.

FIG. 4 illustrates a user interface 400, in accordance with one or more implementations. The user interface 400 may include a view of a portion of a collaboration environment. In particular, the user interface 400 may comprise the interface element first portion 306 of the collaboration environment 302 in FIG. 3. Selection of interface element 402 may display a drop-down menu displaying interface elements used to create work unit records from scratch, create work unit records using a template, and/or create a template. By way of non-limiting illustration, the interface elements may include one or more of a new task option 404 (e.g., generate a work unit record from scratch), a Template A option 406 (e.g., create a work unit record using an existing template called “Template A”), a create template option 408, and/or other options.

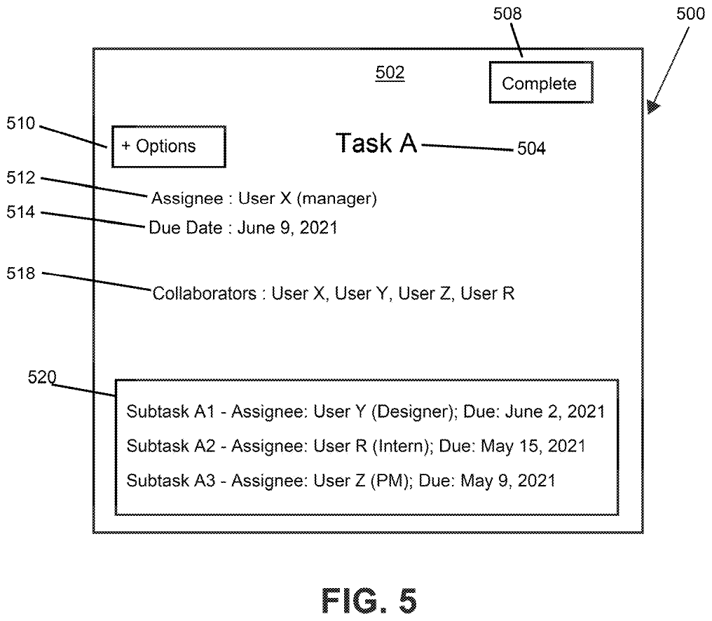

FIG. 5 illustrates a user interface 500, in accordance with one or more implementations. The user interface 500 may include a view of a collaboration environment. In particular, the user interface 500 may comprise a work unit page 502 for a work unit record of a unit of work, referred to for illustrative purposes as “Task A” 504. The work unit page 502 may include a set of interface elements displaying values of work unit parameters of Task A 504. Work unit page 502 may comprise an interface element 508 used to indicate completion of Task A 504. Interface element 510 may include an options interface element the same as or similar to 306 in FIG. 3 and/or 402 in FIG. 4. The work unit page 502 may comprise one or more of an interface element 512 displaying an assignee of Task A 504, an interface element 514 displaying a due date, an interface element 518 displaying collaborators on Task A 504, an interface element 520 displaying a set of subordinate work unit records and/or other content. Individual subordinate work unit records in the set of subordinate work unit records may individually be associated with work unit pages through which users access the subordinate work unit records. In some implementations, the interface element 520 may display some of the values of the work unit parameters of the subordinate work unit records in the set of subordinate work unit records. In some implementations, a user may provide input into interface element 510 to create a template from the set of subordinate work unit records for Task A.

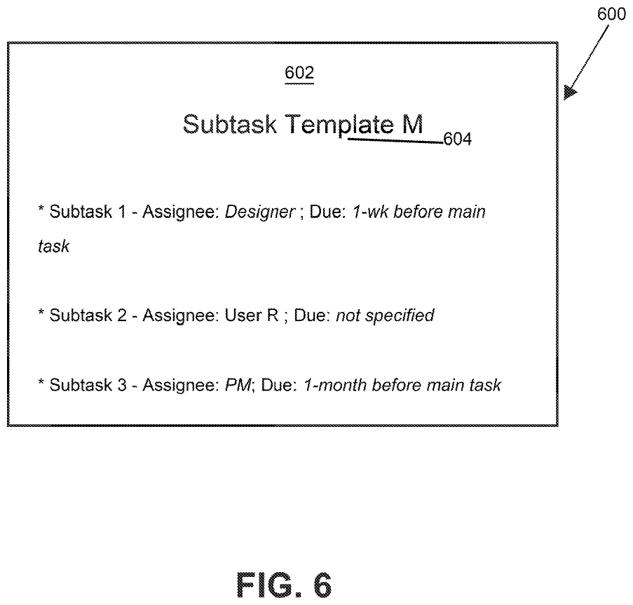

FIG. 6 illustrates a user interface 600, in accordance with one or more implementations. The user interface 600 may comprise a template 602 created based on the set of subordinate work unit records of Task A of FIG. 5 (referred to for illustrative purposes as “Template M” 604). The template 602 may include one or more interface elements configured to display templated work information for the template 602 and/or other information. The templated work information may include one or more of predetermined information, determinable information, and/or other information. The predetermined information may include individual sets of predetermined values for the work unit parameters. The determinable information may include individual sets of determinable values for the work unit parameters, and/or other information. By way of non-limiting illustration, a determinable value of a work assignment parameter for Subtask 1 may include a user having a role of “Designer.” By way of non-limiting illustration, a determinable value of a due date parameter for Subtask 1 may include a date that is 2 weeks before a due date of superior work unit record that implements the template 602. By way of non-limiting illustration, a predetermined value of a work assignment parameter for Subtask 2 may include “User R”. By way of non-limiting illustration, a determinable value of a work assignment parameter for Subtask 3 may include a user having a role of “PM” (project manager). By way of non-limiting illustration, a determinable value of a due date parameter for Subtask 3 may include a date that is 1 month before a due date of superior work unit record that implements the template 602.

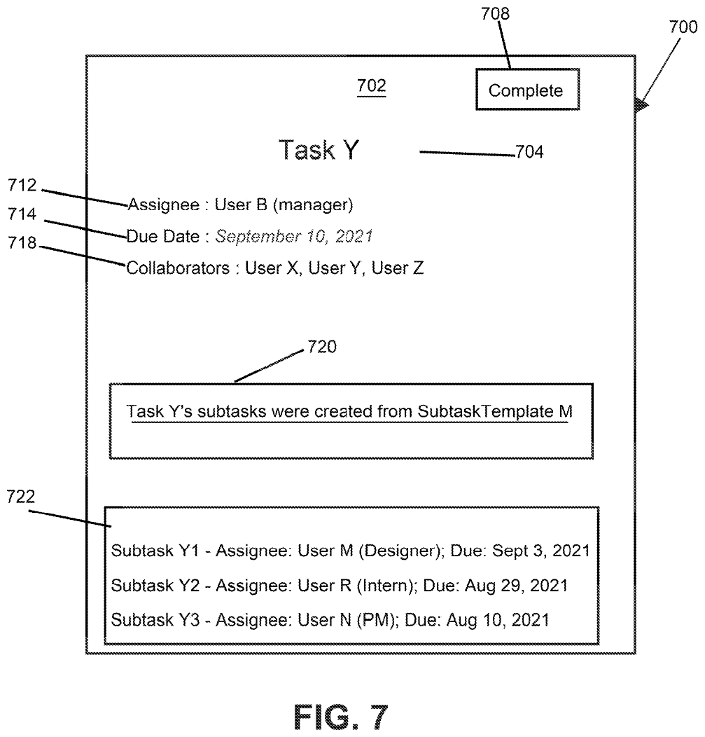

FIG. 7 illustrates a user interface 700, in accordance with one or more implementations. The user interface 700 may comprise a work unit page 702 for work unit record of a unit of work created from Template M of FIG. 6. The unit of work may be referred to for illustrative purposes as “Task Y” 704. The work unit page 702 may include a set of interface elements displaying values of work unit parameters of Task 7 including predetermined information and/or specific determination of the determinable information of Template M. Work unit page 702 may comprise an interface element 708 used to indicate completion of Task Y 704.

The work unit page 702 may comprise one or more of an interface element 712 displaying an assignee of Task Y 704, an interface element 714 displaying a due date, an interface element 718 displaying collaborators, an interface element 720 displaying a description, an interface element 722 displaying a set of subordinate work unit records, and/or other components. As shown, the predetermined information for the instance of Subtask 2 (shown as Subtask Y2) has been carried out, including the assignment to User R. Further, the determinable information may be determined given specification of due date of Task Y and/or assignment to user(s) who fulfill the particular role constraints.

Returning back to FIG. 1, in some implementations, server(s) 102, client computing platform(s) 104, and/or external resource(s) 126 may be operatively linked via one or more electronic communication links. For example, such electronic communication links may be established, at least in part, via a network 117 such as the Internet and/or other networks. It will be appreciated that this is not intended to be limiting, and that the scope of this disclosure includes implementations in which server(s) 102, client computing platform(s) 104, and/or external resource(s) 126 may be operatively linked via some other communication media.

A given client computing platform may include one or more processors configured to execute computer program components. The computer program components may be configured to enable an expert or user associated with the given client computing platform to interface with system 100 and/or external resource(s) 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

Server(s) 102 may include electronic storage 128, one or more processors 130, and/or other components. Server(s) 102 may include communication lines, or ports to enable the exchange of information with the network 117 and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, a physical processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, 114, 116 and/or other components. Processor(s) 130 may be configured to execute components 108, 110, 112, 114, 116 and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, and/or 116 are illustrated in FIG. 1 as being implemented within a single processing unit, in implementations in which processor(s) 130 includes multiple processing units, one or more of components 108, 110, 112, 114, and/or 116 may be implemented remotely from the other components. The description of the functionality provided by the different components 108, 110, 112, 114, and/or 116 described below is for illustrative purposes, and is not intended to be limiting, as any of components 108, 110, 112, 114, and/or 116 may provide more or less functionality than is described. For example, one or more of components 108, 110, 112, 114, and/or 116 may be eliminated, and some or all of its functionality may be provided by other ones of components 108, 110, 112, 114, and/or 116. As another example, processor(s) 130 may be configured to execute one or more additional components that may perform some or all of the functionality attributed below to one of components 108, 110, 112, 114, and/or 116.

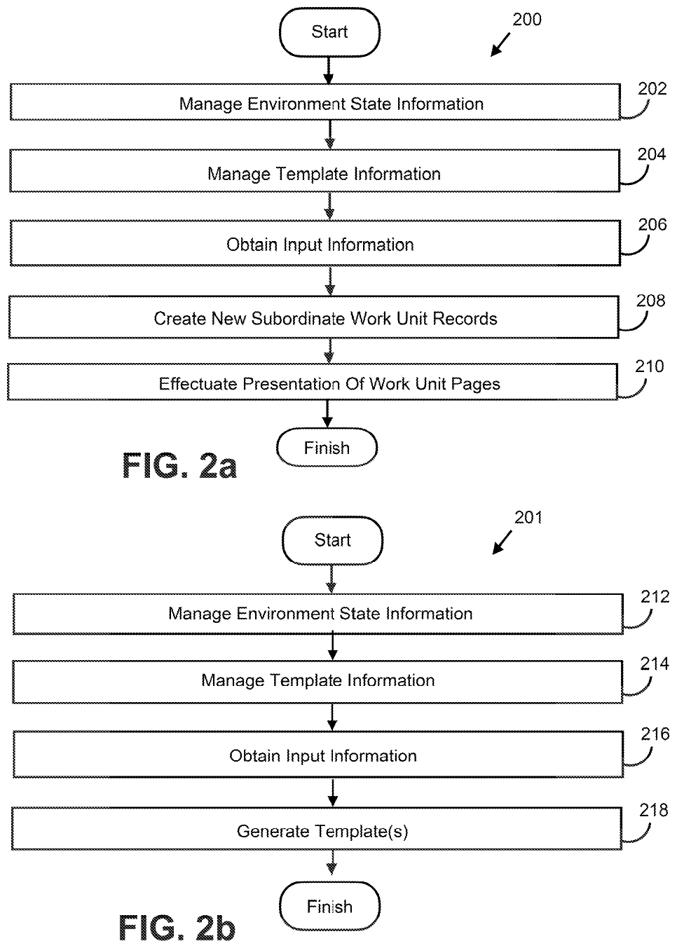

FIG. 2a illustrates a method 200 to generate subordinate work unit records based on templates, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2a and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may manage environment state information maintaining a collaboration environment and/or other information. The collaboration environment may be configured to facilitate interaction by users with the collaboration environment. The environment state information may include one or more records. The one or more records may include one or more of work unit records, user records, and/or other records. The work unit records may include work information associated with units of work managed, created, and/or assigned within the collaboration environment. The user records may include user information associated with the users. The work information may include hierarchical information characterizing a record hierarchy for the work unit records and/or other records. The record hierarchy may specify that individual work unit records are subordinate work unit records and other individual work unit records are superior work unit records. By way of non-limiting illustration, the work unit records may include a first work unit record. Operation 202 may be performed by one or more hardware processors configured by machine-readable instructions including a component that is the same as or similar to environment state component 108, in accordance with one or more implementations.

An operation 204 may manage template information defining templates for the work unit records. Individual templates may facilitate creation of individual sets of subordinate work unit records based on templated work information of the individual templates, and/or other information. By way of non-limiting illustration, a first template may facilitate the creation of a first set of subordinate work unit records based on first templated work information. Operation 204 may be performed by one or more hardware processors configured by machine-readable instructions including a component that is the same as or similar to template component 110, in accordance with one or more implementations.

An operation 206 may obtain input information conveying user input into a user interface of the collaboration environment to implement the templates to create the individual sets of subordinate work unit records. The input information may convey first user input by a first user into the user interface to implement the first template. Operation 206 may be performed by one or more hardware processors configured by machine-readable instructions including a component that is the same as or similar to user input component 112, in accordance with one or more implementations.

An operation 208 may create the individual sets of subordinate work unit records based on the implementation of the templated work information of the individual templates and/or other information. The first set of subordinate work unit records may be created based on an implementation of the first templated work information of the first template and/or other information. The first set of subordinate work unit records may be created as being subordinate to the first work unit record. Operation 208 may be performed by one or more hardware processors configured by machine-readable instructions including a component that is the same as or similar to the records component 114, in accordance with one or more implementations.

An operation 210 may effectuate presentation of work unit pages of the work unit records through which the users access the work unit records. A first work unit page for the first work unit record may be presented. The first work unit page may display the first set of subordinate work unit records that are subordinate to the first work unit record, and/or other information. Operation 210 may be performed by one or more hardware processors configured by machine-readable instructions including a component that is the same as or similar to the user interface component 116, in accordance with one or more implementations.

FIG. 2b illustrates a method 201 to create one or more templates based on subordinate work unit records of a collaboration environment, in accordance with one or more implementations. The operations of method 201 presented below are intended to be illustrative. In some implementations, method 201 may be accomplished with one or more additional operations not described, and/or without one or more of the operations discussed. Additionally, the order in which the operations of method 201 are illustrated in FIG. 2b and described below is not intended to be limiting.

In some implementations, method 201 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 201 in response to instructions stored electronically on an electronic storage medium. The one or more processing devices may include one or more devices configured through hardware, firmware, and/or software to be specifically designed for execution of one or more of the operations of method 201.

An operation 212 may manage environment state information maintaining a collaboration environment and/or other information. The collaboration environment may be configured to facilitate interaction by users with the collaboration environment. The environment state information may include one or more of work unit records, user records, and/or other records. The work unit records may include work information associated with units of work managed, created, and/or assigned within the collaboration environment. The user records may include user information associated with the users. The work information may include hierarchical information characterizing a record hierarchy for the work unit records and/or other record. The record hierarchy may specify that individual work unit records are subordinate work unit records and other individual work unit records are superior work unit records. The work unit records may include a first superior work unit record and a first set of subordinate work unit records that are subordinate to the first superior work unit record. Operation 212 may be performed by one or more hardware processors configured by machine-readable instructions including a component that is the same as or similar to environment state component 108, in accordance with one or more implementations.

An operation 214 may manage template information defining templates for the work unit records. Individual templates may facilitate the creation of individual sets of subordinate work unit records based on templated work information of the individual templates, and/or other information. Operation 214 may be performed by one or more hardware processors configured by machine-readable instructions including a component that is the same as or similar to template component 110, in accordance with one or more implementations.

An operation 216 may obtain input information conveying user input into a user interface of the collaboration environment to generate one or more of the templates based on one or more of the subordinate work unit records included in the environment state information. The input information may convey first user input by a first user to generate a first template based on the first set of subordinate work unit records. Operation 216 may be performed by one or more hardware processors configured by machine-readable instructions including a component that is the same as or similar to user input component 112, in accordance with one or more implementations.

An operation 218 may generate, in response to the user input, the one or more of the templates based on the one or more of the subordinate work unit records included in the environment state information. By way of non-limiting illustration, the first template may be generated based on the first set of subordinate work unit records. The first template may include first templated work information. Operation 218 may be performed by one or more hardware processors configured by machine-readable instructions including a component that is the same as or similar to the template component 110, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured to generate subordinate work unit records based on record templates, the system comprising:
non-transitory electronic storage storing environment state information maintaining a virtual collaboration environment, the environment state information including electronically stored work unit records and user records, the work unit records including work information associated with units of work managed, created, and/or assigned within the virtual collaboration environment, the user records including user information associated with the users, wherein the work information includes hierarchical information characterizing record hierarchies for the work unit records, wherein the record hierarchies convey hierarchical relationships by identifying individual work unit records as subordinate work unit records and other individual work unit records as superior work unit records, wherein the hierarchical relationships define dependency restrictions impacting eligibility to change completion state of the individual work unit records, wherein one of the work unit records corresponds to one of the units of work, and wherein the work unit records include a first work unit record corresponding to a first unit of work, and a second work unit record corresponding to a second unit of work; and
one or more physical processors configured by machine-readable instructions to:
manage, by a server, the environment state information to facilitate interaction by users with the virtual collaboration environment, the users interacting with the virtual collaboration environment through remotely located client computing platforms communicating with the server over one or more network connections;
manage, by the server, template information defining record templates, individual record templates facilitating creation of individual sets of new subordinate work unit records for new individual record hierarchies, the new individual record hierarchies conveying new individual hierarchical relationships by identifying the individual work unit records that become superior to the individual sets of new subordinate work unit records, wherein the creation is based on templated work information of the individual record templates that causes new work information of the individual sets of new subordinate work unit records to be automatically prepopulated upon implementation of the individual record templates, wherein at least some of the new work information is dictated by the individual work unit records that become superior to the individual sets of new subordinate work unit records, such that a first record template facilitates creation of a first set of new subordinate work unit records based on first templated work information;
establish the one or more network connections between the server and the remotely located client computing platforms;
obtain, by the server, input information conveying user input into a graphical user interface of the virtual collaboration environment presented by the remotely located client computing platforms, wherein the user input includes selection of the individual work unit records, and selection from a drop-down menu to implement the record templates to create the individual sets of new subordinate work unit records with respect to selected ones of the individual work unit records, such that the input information conveys first user input by a first user into the graphical user interface to implement the first record template with respect to the first work unit record;
identify, by the server and based on the input information, the individual work unit records for which the individual sets of new subordinate work unit records are to be created, including identifying, from the first user input, the first work unit record has been selected to be superior to the first set of new subordinate work unit records created from the first record template;
responsive to the user input and identifying the individual work unit records, create, by the server, the individual sets of new subordinate work unit records and the new individual record hierarchies based on the implementation of the templated work information of the individual record templates, such that the first set of new subordinate work unit records is created based on an implementation of the first templated work information of the first record template, wherein the first set of new subordinate work unit records is created as being subordinate to the first work unit record within a first new record hierarchy, and wherein first new work information of the first set of new subordinate work unit records is dictated by the first work unit record so that the first set of new subordinate work unit records take on some of the work information from the first work unit record;
effectuate storage, within the non-transitory electronic storage, of new hierarchical information in the selected ones of the individual work unit records, the new hierarchical information characterizing the new individual record hierarchies, such that first new hierarchical information characterizing the first new record hierarchy is stored in the first work unit record; and
effectuate communication of user interface information from the server to the remotely located client computing platforms over the one or more network connections, wherein receipt of the user interface information causes the remotely located client computing platforms to present work unit pages of the work unit records in the graphical user interface of the virtual collaboration environment, the work unit pages providing access to the work unit records, such that a first work unit page for the first work unit record is presented, the first work unit page providing access to the first work unit record and the first set of new subordinate work unit records that is subordinate to the first work unit record.

2. The system of claim 1, wherein the one or more physical processors are further configured by the machine-readable instructions to:
obtain context information conveying context of the user input to implement the record templates; and
create the individual sets of new subordinate work unit records by determining the new work information for created ones of the subordinate work unit records based on the context information and the templated work information.

3. The system of claim 2, wherein the context of the user input includes one or more of an identity of an individual user providing the user input to implement the individual record templates, a record associated with a source page in which the user input to implement the individual record templates is provided, one or more users linked to the record associated with the source page, or a date and/or time of the user input to implement the individual record templates.

4. The system of claim 2, wherein determining the new work information for the created ones of the subordinate work unit records based on the context information includes applying one or more rules which dictate how the context information impacts the record templated work information.

5. The system of claim 4, wherein the templated work information specifies that at least some of the new work information for the created ones of the subordinate work unit records is predetermined and unimpacted by the context information.

6. A system configured to create templates for work unit records of a virtual collaboration environment, the system comprising:
non-transitory electronic storage storing environment state information maintaining a virtual collaboration environment, the environment state information including electronically stored work unit records and user records, the work unit records including work information associated with units of work managed, created, and/or assigned within the virtual collaboration environment, the user records including user information associated with the users, wherein the work information includes hierarchical information characterizing record hierarchies for the work unit records, wherein the record hierarchies convey hierarchical relationships by identifying individual work unit records as subordinate work unit records and other individual work unit records as superior work unit records, wherein the hierarchical relationships define dependency restrictions impacting eligibility to change completion state of the individual work unit records, wherein one of the work unit records corresponds to one of the units of work, wherein the work unit records include a first superior work unit record corresponding to a first unit of work, and a first set of subordinate work unit records corresponding to a first set of units of work, wherein the first of set of subordinate work unit records are subordinate to the first superior work unit record in accordance with a first record hierarchy;
one or more physical processors configured by machine-readable instructions to:
manage, by a server, the environment state information to facilitate interaction by users with the virtual collaboration environment, the users interacting with the virtual collaboration environment through remotely located client computing platforms communicating with the server over one or more network connections;
manage, by the server, template information defining record templates, individual record templates facilitating creation of individual sets of new subordinate work unit records and new record hierarchies based on templated work information of the individual record templates;
establish the one or more network connections between the server and the remotely located client computing platforms;
effectuate communication of user interface information from the server to the remotely located client computing platforms over the one or more network connections, wherein receipt of the user interface information causes the remotely located client computing platforms to present a graphical user interface of the virtual collaboration environment;
obtain, by the server, input information conveying user input into the graphical user interface of the virtual collaboration environment including selection of individual superior work unit records, and selection from a drop-down menu to generate new record templates, wherein the new record templates are generated based on one or more of the subordinate work unit records which are subordinate to selected ones of the individual superior work unit records so that the new record templates are derived from the work information of the one or more of the subordinate work unit records, the input information conveying first user input by a first user to generate a first new record template based on the first set of subordinate work unit records which are subordinate to the first superior work unit record; and
generate, by the server and in response to the user input, the new record templates by deriving the new record templates from the one or more of the subordinate work unit records which are subordinate to the selected ones of the individual superior work unit records, the new record templates being derived from the one or more of the subordinate work unit records by determining constraints applied to the one or more of the subordinate work unit records, such that the first new record template is generated based on the first set of subordinate work unit records, the first new record template including first templated work information derived from the first set of subordinate work unit records by determining a first set of constraints of associated with the first set of subordinate work unit records.

7. The system of claim 6, wherein the one or more physical processors are further configured by the machine-readable instructions to:
obtain context information conveying context of the work information of the one or more of the subordinate work unit records from which the new record templates are generated; and
determine the templated work information of the new record templates based on the context information, such that the first templated work information for the first new record template is determined based on the context of the work information for the first set of subordinate work unit records.

8. The system of claim 7, wherein the context of the work information includes one or more of a role constraint, a date constraint, a source record constraint.

9. The system of claim 8, wherein the templated work information is associated with one or more rules, wherein individual rules dictate how the context impacts the templated work information.

10. The system of claim 9, wherein at least some of the templated work information is predetermined and unimpacted by the context information.

11. A method to generate subordinate work unit records based on record templates, the method comprising:
storing, by non-transitory electronic storage, environment state information maintaining a virtual collaboration environment, the environment state information including electronically stored work unit records and user records, the work unit records including work information associated with units of work managed, created, and/or assigned within the virtual collaboration environment, wherein one of the work unit records corresponds to one of the units of work, the user records including user information associated with the users, wherein the work information includes hierarchical information characterizing record hierarchies for the work unit records, wherein the record hierarchies convey hierarchical relationships by identifying individual work unit records as subordinate work unit records and other individual work unit records as superior work unit records, wherein the hierarchical relationships define dependency restrictions impacting eligibility to change completion state of the individual work unit records, and wherein the work unit records include a first work unit record corresponding to a first unit of work, and a second work unit record corresponding to a second unit of work;
managing, by a server, the environment state information to facilitate interaction by users with the virtual collaboration environment, the users interacting with the virtual collaboration environment through remotely located client computing platforms communicating with the server over one or more network connections;
managing, by the server, template information defining record templates, individual record templates facilitating creation of individual sets of new subordinate work unit records for new individual record hierarchies, the new individual record hierarchies conveying new hierarchical relationships by identifying the individual work unit records that become superior to the individual sets of new subordinate work unit records, wherein the creation is based on templated work information of the individual record templates that causes new work information of the individual sets of new subordinate work unit records to be automatically prepopulated upon implementation of the individual record templates, wherein at least some of the new work information is dictated by the individual work unit records that become superior to the individual sets of new subordinate work unit records, such that a first record template facilitates creation of a first set of new subordinate work unit records based on first templated work information;
establishing the one or more network connections between the server and the remotely located client computing platforms;
obtaining, by the server, input information conveying user input into a graphical user interface of the virtual collaboration environment presented by the remotely located client computing platforms, wherein the user input includes selection of the individual work unit records, and selection from a drop-down menu to implement the record templates to create the individual sets of new subordinate work unit records with respect to selected ones of the individual work unit records, including obtaining first user input by a first user into the graphical user interface to implement the first record template with respect to the first work unit record;
identifying, by the server and based on the input information, the individual work unit records for which the individual sets of new subordinate work unit records are to be created, including identifying, from the first user input, the first work unit record has been selected to be superior to the first set of new subordinate work unit records created from the first record template;
responsive to the user input and identifying the individual work unit records, creating, by the server, the individual sets of new subordinate work unit records and the new individual record hierarchies based on the implementation of the templated work information of the individual record templates, including creating the first set of new subordinate work unit records based on an implementation of the first templated work information of the first record template, wherein the first set of new subordinate work unit records is created as being subordinate to the first work unit record within a first new record hierarchy, and wherein first new work information of the first set of new subordinate work unit records is dictated by the first work unit record so that the first set of new subordinate work unit records take on some of the work information from the first work unit record;
effectuating storage, within the non-transitory electronic storage, of new hierarchical information in the selected ones of the individual work unit records, the new hierarchical information characterizing the new individual record hierarchies, such that first new hierarchical information characterizing the first new record hierarchy is stored in the first work unit record; and
effectuating communication of user interface information from the server to the remotely located client computing platforms over the one or more network connections, wherein receipt of the user interface information causes the remotely located client computing platforms to present work unit pages of the work unit records in the graphical user interface of the virtual collaboration environment, the work unit pages providing access to the work unit records, including effectuating communication of the user interface information which causes presentation of a first work unit page for the first work unit record, the first work unit page providing access to the first work unit record and the first set of new subordinate work unit records that is subordinate to the first work unit record.

12. The method of claim 11, further comprising:
obtaining context information conveying context of the user input to implement the record templates; and
creating the individual sets of new subordinate work unit records by determining the new work information for created ones of the subordinate work unit records based on the context information and the templated work information.

13. The method of claim 12, wherein the context of the user input includes one or more of an identity of an individual user providing the user input to implement the individual record templates, a record associated with a source page in which the user input to implement the individual record templates is provided, one or more users linked to the record associated with the source page, or a date and/or time of the user input to implement the individual record templates.

14. The method of claim 12, wherein determining the new work information for the created ones of the subordinate work unit records based on the context information includes applying one or more rules which dictate how the context information impacts the templated work information.

15. The method of claim 14, wherein the templated work information specifies that at least some of the new work information for the created ones of the subordinate work unit records is predetermined and unimpacted by the context information.

16. The method of claim 11, wherein the input information further conveys further user input into the graphical user interface of the virtual collaboration environment to generate new record templates based on one or more of the subordinate work unit records already included in the environment state information, the input information conveying second user input by a second user to generate a second record template based on a second set of subordinate work unit records, and, wherein the method further comprises:
generating, in response to the further user input, the new record templates based on the one or more of the subordinate work unit records included in the environment state information, the new record templates being derived from the one or more of the subordinate work unit records by determining constraints applied to the one or more of the subordinate work unit records, such that the second record template is generated based on the second set of subordinate work unit records, the second record template including second templated work information derived from the second set of subordinate work unit records by determining a first set of constraints of associated with the second set of subordinate work unit records.

17. The method of claim 16, further comprising:
obtaining further context information conveying context of the work information of the one or more of the subordinate work unit records from which the new record templates are generated; and
determine the templated work information based on the context information, such that the second templated work information for the second record template is determined based on the context of the work information for the second set of subordinate work unit records.

18. The method of claim 17, wherein the context of the work information includes one or more of a role constraint, a date constraint, a source record constraint.

19. The method of claim 18, wherein the templated work information is associated with one or more rules, wherein individual rules dictate how the context impacts the templated work information.

20. The method of claim 19, wherein at least some of the templated work information is predetermined and unimpacted by the context information.
